(19) United States
(12) Patent Application Publication
(10) Pub. No.: US 2021/0402890 A1
(43) Pub. Date: Dec. 30, 2021

(54) CHARGING DEVICES AND RELATED SYSTEMS AND METHODS FOR CHARGING AREA MANAGEMENT OF ELECTRONIC VEHICLES

(71) Applicant: Noodoe Corporation, Taipei City (TW)

(72) Inventors: Yi-An Hou, Taipei City (TW); Chun-Hung Kung, Taipei City (TW); Chia-Ying Kao, Taipei City (TW); Hang-An Liu, Taipei City (TW)

(21) Appl. No.: 17/302,150

(22) Filed: Apr. 26, 2021

(30) Foreign Application Priority Data
Jun. 30, 2020 (TW) 109122128

(51) Int. Cl. B60L 53/66; B60L 53/62; B60L 53/65; B60L 53/30; G06Q 30/04

(52) U.S. Cl. CPC B60L 53/665; B60L 53/62; G06Q 30/04; B60L 53/305; B60L 53/65

(57) ABSTRACT

A method for charging area management of electric vehicles is provided for managing billing of a charging area of electric vehicles. An existence of an object in the charging area is detected and object data corresponding to the object is then obtained from the object and a status of the charging device is obtained. It is then determined whether an occupancy event has occurred on the object according to the obtained status of the charging device. When it is determined that the occupancy event has occurred on the object, a billing operation corresponding to the object is performed based on the object data.

### BACKGROUND OF THE INVENTION

### Field of the Invention

The disclosure relates generally to management systems and methods thereof, and, more particularly to management systems and methods that can perform related managements for a charging area corresponding to electric vehicles.

### Description of the Related Art

Recently, with the rising awareness of environmental protection and electric vehicle technology advances, the development of electric vehicles powered by electrical energy to replace traditional vehicles powered by fossil fuels has gradually become an important goal in the automotive field, thus making electric vehicles become more and more popular. In order to increase the range and willingness to use electric vehicles, many countries or cities have begun to set up charging stations in public places to provide electricity to electric vehicles, and have also begun to plan the deployment of a large number of charging stations in urban areas or scenic areas, so as to make the charging of electric vehicles more convenient.

However, the use of conventional charging stations is to use a charging device corresponding to a specific parking space (also referred to as the electric vehicle parking space) and the space is limited. When a vehicle is using the specific parking space, it may only park at the specific parking space without charging or it may park and charge at the specific parking space at the same time. Unfortunately, the charging station can't clearly know the usage status of the vehicle at the specific parking space, so that the specific parking space may he occupied by non-electric vehicles or the electric vehicles does not be moved after the charging operation is completed, which affects the charging of other electric vehicles, thereby causing both the charging station operators and users to be unable to achieve the best protection of rights and interests.

### BRIEF SUMMARY OF THE INVENTION

Charging devices and related systems and methods for charging area management of electric vehicles are provided, which can manage a charging area corresponding to electric vehicle (e.g., exclusive parking space for electric vehicles corresponding to the charging device), and can determine whether to charge parking fees for a vehicle according to its vehicle data, a status of the charging device and predetermined billing conditions, and when the charging device detects that a vehicle in its corresponding charging area triggers a billing condition, automatically start to calculate the parking fee for the vehicle, so a certain deterrent effect can be produced by the user payment mechanism, which effectively reduces the chance that the corresponding charging area of the charging device is occupied by non-electric vehicles or electric vehicles that are not charging for a long time or unlimited time, so as to improve the practicability and utilization rate of the charging device.

An embodiment of a charging device for outputting electric power to charge an electric vehicle, comprises: an object sensing unit configured to detect an existence of an object in a charging area, and obtain corresponding object data from the object; and a processor coupled to the object sensing unit, configured to obtain a status of the charging device when receiving the object data from the object sensing unit, determine whether an occupancy event has occurred on the object according to the obtained status of the charging device, and perform a billing operation corresponding to the object based on the object data in response to determining that the occupancy event has occurred on the object.

An embodiment of a management system comprises: a computer device; and a charging device for outputting electric power to charge an electric vehicle, wherein the charging device is connected to the computer device via a communication network, comprising: an object sensing unit configured to detect an existence of an object in a charging area, and obtain corresponding object data from the object; and a processor coupled to the object sensing unit, configured to transmit the object data to the computer device upon receiving the object data from the object sensing unit to enable the computer device to obtain a status of the charging device, determine whether an occupancy event has occurred on the object according to the obtained status of the charging device, and perform a billing operation corresponding to the object based on the object data in response to determining that the occupancy event has occurred on the object.

In an embodiment of a method for charging area management of electric vehicles for managing billing of a charging area of electric vehicles, an existence of an object in the charging area is first detected and object data corresponding to the object is then obtained from the object and a status of the charging device is obtained. It is then determined whether an occupancy event has occurred on the object according to the obtained status of the charging device. When it is determined that the occupancy event has occurred on the object, a billing operation corresponding to the object is performed based on the object data.

In some embodiments, the determination of whether the occupancy event has occurred on the object further includes the steps of determining whether the charging device is not in a charging status for more than a predetermined time period and determining that the occupancy event has occurred on the object when the charging device is not in the charging status for more than the predetermined time period.

In some embodiments, the performance of the billing operation corresponding to the object based on the object data includes the steps of executing an object recognition procedure to determine whether the object is an electric vehicle based on the object data, performing the billing operation corresponding to the object with a first pricing rate when it is determined that the object is the electric vehicle and performing the billing operation corresponding to the object with a second pricing rate when it is determined that the object is not the electric vehicle, wherein the second pricing rate is higher than the first pricing rate.

In some embodiments, the first pricing rate and the second pricing rate can be fixed pricing rates. In other embodiments, the first pricing rate can be a fixed pricing rate and the second pricing rate can be a progressive pricing rate.

In some embodiments, the object recognition procedure includes parsing the object data to obtain a vehicle identification data, querying related information corresponding to the vehicle based on the vehicle identification data, and determining whether the object is an electric vehicle based on the related information corresponding to the vehicle. The vehicle identification data can be a license plate number of the vehicle.

In some embodiments, the object data is image data obtained by shooting the object. The object data can include a license plate image data.

In some embodiments, the object data is electronic tag data obtained from an electronic tag placed on the object. The object data can include vehicle electronic tag data.

In some embodiments, the first pricing rate and the second pricing rate can be fixed pricing rates. In other embodiments, the first pricing rate can be a fixed pricing rate and the second rate can be a progressive pricing rate.

In some embodiments, the charging device further includes a communication unit for transmitting messages to and receiving messages from a communication network. When the processing unit executes the object recognition procedure, it transmits the object data to an external computer device through the communication unit, such that the external computer device parses the object data to obtain a vehicle identification data, queries related information corresponding to the vehicle based on the vehicle identification data, and determines whether the object is an electric vehicle based on the related information corresponding to the vehicle.

In some embodiments, the method further includes determining whether the charging device is not in the charging status according to a determination of whether the charging device is connected to an object and detecting whether the charging device has output power.

In some embodiments, the charging device further includes an alarm unit for generating an alarm signal to perform a notification and alarm operation on the object.

Methods for charging area management of electric vehicles may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of an environment suitable for a charging device and a charging management server corresponding thereto of the invention;

FIG. 2 is a schematic diagram illustrating an embodiment of a charging device of the invention;

FIG. 3 is a schematic diagram illustrating an embodiment of a charging management server of the invention; and

FIG. 4 is a flowchart of an embodiment of a method for charging area management of electric vehicles of the invention.

### DETAILED DESCRIPTION OF THE INVENTION

The following description is of the best-contemplated mode of carrying out the invention. This description is made for the purpose of illustrating the general principles of the invention and should not be taken in a limiting sense. It should be understood that the embodiments may be realized in software, hardware, firmware, or any combination thereof.

Embodiments of the invention provide charging devices and related systems and methods for charging area management of electric vehicles, which can manage a charging area corresponding to electric vehicles (e.g., the exclusive electric vehicle parking space corresponding to the charging device of the electric vehicle), which can determine whether to charge parking fees for a vehicle based on its vehicle data, a status of the charging device and predetermined charging/billing conditions, and automatically perform a billing operation to calculate the parking fee for the vehicle when the charging device detects that a vehicle in its corresponding charging area has an occupancy event, such that the charging device automatically performs or notifies the cloud to perform a billing operation to start calculating the parking fee when an electric vehicle is parked at the charging area without performing the charging operation (including the electric vehicle whose charging operation is not be performed or the electric vehicle whose charging operation is completed) for more than a certain time period or when a traditional vehicle powered by fossil fuels is parked at the charging area, a notification and alarm operation can be performed to notify the driver of the traditional vehicle powered by fossil fuels to move his/her vehicle within a predefined time period or notify the driver that a billing operation is about to start if the vehicle is not moved within the predefined time period. After the notification and alarm operation is performed for a certain time period (a tolerance time period or a preferential time period), the parking fee will start to be calculated. Therefore, a certain deterrent effect can be generated by the user payment mechanism, which effectively reduces the opportunity for the charging area corresponding to the charging device being occupied by non-electric vehicles or electric vehicles that are not charging for a long time or unlimited time, thus effectively improving the practicality and utilization rate of charging device.

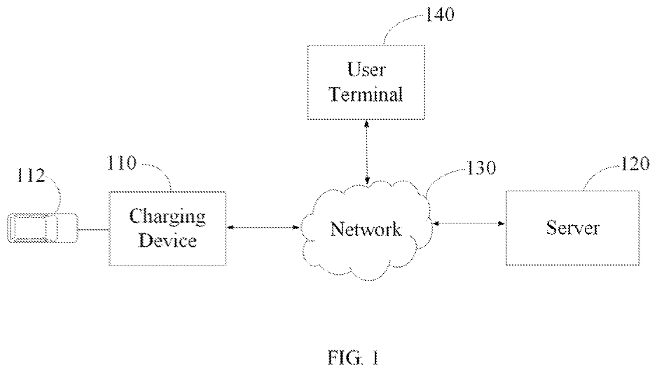

FIG. 1 is a schematic diagram illustrating an embodiment of an environment suitable for a charging device and a charging management server corresponding hereto of the invention. As shown in FIG. 1, a charging management server 120 of the present invention is remotely connected to a charging device 110 and a user terminal 140 via a network 130. In some embodiments, the network 130 may be a wired network, a telecommunication network, and a wireless network, such as a Wi-Fi network or the like. The server 120 can receive various data from the charging device 110. For example, the server 120 may receive an object detection signal obtained by the charging device for detecting an existence of an object 112 in a predetermined space, and obtain corresponding object data from the: object 112. For example, the predetermined space may be the charging area corresponding to the charging device (hereinafter referred to as the electric vehicle parking space), the object 112 may be a vehicle parked at the electric vehicle parking space, and the object data may be related information of the vehicle, such as the license plate number, the brand and the type for the vehicle and so on, but the invention is not limited thereto. The server 120 may also directly or indirectly receive a charging request from the user terminal 140, and after completing payment confirmation and other actions according to the charging request, it generates a charging authorization instruction and transmits it to the charging device 110 via the network 130, so as to allow the charging device 110 to output power starting at a certain time to an electric vehicle (for example, an electric scooters or an electric car) which is electronically connected to the charging device 110 or prohibit the charging device 110 from outputting power to the electric vehicle. For example, in one embodiment, the object 112 can be an electric vehicle and the charging device 110 can be an electric vehicle charger, which may have a single charging connector or multiple charging connectors, and can output electric power to charge the electric vehicle through the charging connector(s).

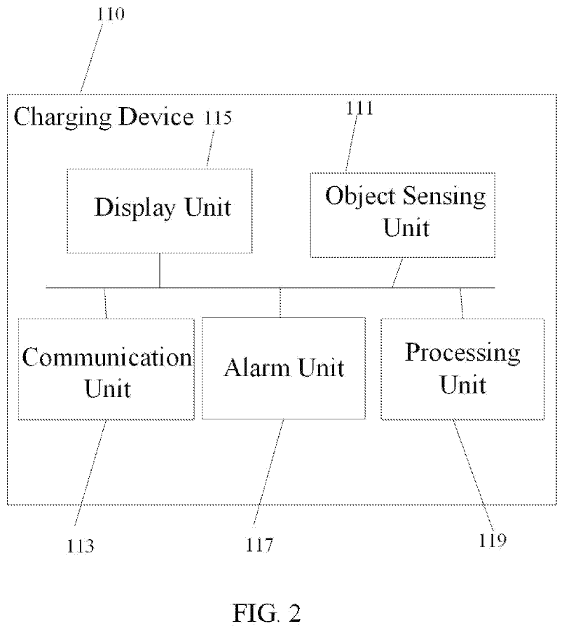

FIG. 2 is a schematic diagram illustrating an embodiment of a charging device of the invention. As shown in FIG. 2, the charging device 110 of the invention can be an electric vehicle charger or a charging station and other devices used to output power o charge an electric vehicle, which comprises at least an object sensing unit 111, a communication unit 113, a display unit 115, an alarm unit 117 and a processing unit 119. It should be noted that, the charging management server 120 can perform charging management operations of the charging device 110. The charging management operations may include reservation scheduling management of the charging device 110 and related payment operations.

The object sensing unit 111 senses the existence of an object in a predetermined space, and obtains corresponding object data from the object. For example, the object sensing unit 111 may be a camera that detects/senses the existence of an object (for example, a vehicle) in a predetermined space such as a charging area corresponding to the charging device. When the object sensing unit 111 is a camera, the object data is an image data obtained by shooting the object. When the object is a vehicle, the image data serving as the object data taken by the camera (served as the object sensing unit 111) may comprise image data corresponding to a license plate of the vehicle. For example, the object sensing unit 111 can also be an electronic tag reader, which can automatically read the data recorded in the electronic tag placed on the object. When the object sensing unit 111 is an electronic tag reader, the object data is the electronic tag data obtained from an electronic tag equipped with the object. For example, if the object is a vehicle, when the vehicle is equipped with a vehicle electronic tag that records data such as a license plate number, the electronic tag data read by the electronic tag reader serving as the object sensing unit 111 may include the vehicle electronic tag data corresponding to the vehicle, and it contains vehicle-related data such as the license plate number and so on.

The communication unit 113 is configured to transmit and receive messages through a communication network.

The display unit 115 is configured to display information related to the charging operation of the charging device 110. The alarm unit 117 is configured to generate an alarm signal such as a warning voice or visual effect in response to a notification and alarm operation to notify the user of the object 112 (e.g., the driver/owner of the vehicle) to drive the vehicle away from the charging area for the charging device within a limited time, or notify the user that a billing operation will soon be started. For example, in one embodiment, the alarm unit 117 can be a siren or a speaker, and when the alarm operation is started, it can play audio or voice data, such as “This parking space is a parking space dedicated to charging electric vehicles. Non-charging vehicles will start charging certain fees. Please move your car away within ten minutes, thank you for your cooperation”, to inform the owner of the vehicle to move the car away within said time limit or to inform that the parking fee is about to be calculated.

The processing unit 119 is coupled to the object sensing unit 111, the display unit 115, the alarm unit 117 and the communication unit 113. When receiving the object data from the object sensing unit 111 it obtains a status of the charging device 110, determines whether an occupancy event has occurred on the object 112 according to the obtained status of the charging device 110, and perform a billing operation corresponding to the object 112 based on the object data in response to determining that the occupancy event has occurred on the object 112.

In some embodiments, the processing unit 119 determines whether the occupancy event has occurred on the object 112 according to the obtained status of the charging device 110 further comprises the steps of determining whether the charging device 110 is not in a charging status for more than a predetermined time period and determining that the occupancy event has occurred on the object 112 when the charging device is not in the charging status for more than the predetermined time period.

In some embodiments, the processing unit 119 performs the billing operation corresponding to the object 112 based on the object data further comprises the steps of executing an object recognition procedure to determine whether the object 112 is an electric vehicle based on the object data. When it is determined that the object 112 is an electric vehicle and the electric vehicle remains uncharged (that is, the charging device 110 is not in a charging status) in the charging area for a predetermined period of time, or the object 112 is not an electric vehicle (for example: traditional vehicle powered by fossil fuels), it starts calculating the parking fees. For example, it performs the billing operation corresponding to the object with a first pricing rate when it is determined that the object 112 is the electric vehicle and performs the billing operation corresponding to the object 112 with a second pricing rate when it is determined that the object is not the electric vehicle, wherein the second pricing rate is higher than the first pricing rate. In some embodiments, the first pricing rate and the second pricing rate can be fixed pricing rates. In other embodiments, the first pricing rate can be a fixed pricing rate and the second pricing rate can be a progressive pricing rate.

The object recognition procedure may parse the object data to obtain a vehicle identification data, and determine whether the object 112 is an electric vehicle based thereon. The vehicle identification data can be the license plate number of a vehicle, but the invention is not limited thereto.

In some embodiments, the object recognition procedure and the determination of whether an occupancy event has occurred on the object 112 can be performed by a processor (e.g., the processing unit 119), or can be performed by a remote server. When the object recognition procedure and the determination of whether the occupancy event has occurred on the object 112 are performed by the remote server, the processing unit 119 may determine whether the occupancy event has occurred on the object 112 and enable the object recognition procedure to be performed by transmitting the object data to an external device (such as a remote server) through the communication unit 113 to enable the remote server to detect the status of the charging device 110 and parse the object data to obtain a vehicle identification data, and then determine whether the object 112 is an electric vehicle and whether the occupancy event has occurred on the object 112.

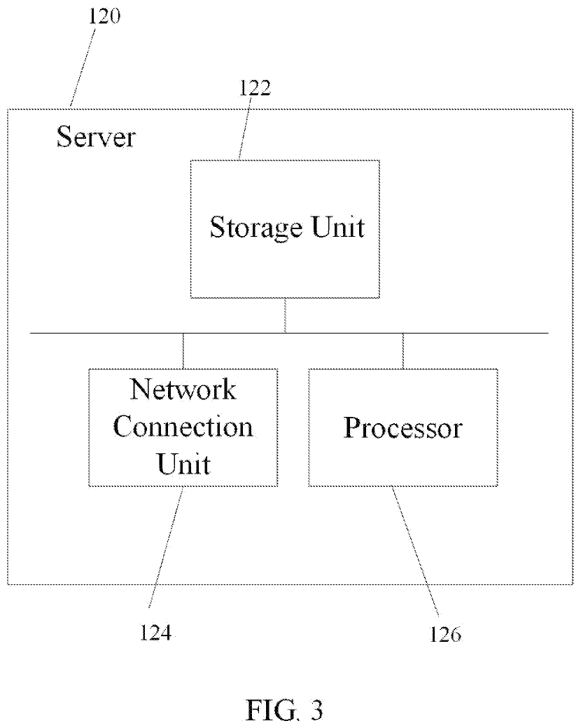

FIG. 3 is a schematic diagram illustrating an embodiment of a server of the invention. As shown in FIG. 3, the server 120 of the invention can be any processor-based electronic device, which comprises at least a storage unit 122, a network connection unit 124, and a processor 126. It should be noted that, the server 120 can receive various data corresponding to a plurality of charging devices 110. For example, the server 120 may receive an object detection signal obtained by a specific charging device for detecting an existence of an object 112 in a predetermined space, and obtain corresponding object data from the object 112. The server 120 may also detect the status of a specific charging device and determine whether the specific charging device is in a charging status based thereon. In some embodiments, the detection of the existence of the object or the acquisition of the object data may not be completed by the charging device itself, but by other devices corresponding to the charging device, such as a monitor installed in a parking lot. The server 120 may receive an object detection signal obtained by detecting the existence of an object in a charging area corresponding to a charging device, and obtain corresponding object data from the object. The server 120 may further directly or indirectly receive a charging request from the user terminal 140, and after completing payment confirmation and other actions according to the charging request, it generates a charging authorization instruction and transmits it to the charging device 110 via the network 130, so as to allow the charging device 110 to output power starting at a certain time to an electric vehicle (for example, an electric scooters or an electric car) which is electronically connected to the charging device 110 or prohibit the charging device 110 from outputting power to the electric vehicle. The charging device 110 corresponding to the server 120 can be an electric vehicle charger, which may have a single charging connector or multiple charging connectors, and can output electric power to charge the electric vehicle through the charging connector(s). The network connection unit 124 can receive the coupling of different charging devices via a network, such as a wired network, a telecommunication network, and a wireless network, such as a Wi-Fi network, and can transmit related data to different charging devices via the network is used to control whether each charging device can output power o charge an electric vehicle.

The storage unit 122 (e.g., a memory or a database) can store and record related data, such as charging device and its corresponding charging service member data, vehicle identification data and its corresponding vehicle-related data. For example, the aforementioned charging service member data may include user identification data that has been registered as the charging service object in advance, payment data, vehicle identification data serving as the charging object, and vehicle identification data corresponding thereto and so on. In addition to vehicle identification data that has been registered as the charging service object in advance, the vehicle identification data may further include vehicle identification data of a vehicle that has not been registered as a charging service object in advance. It is noted that, above data is merely examples of the application, and the present invention is not limited thereto.

Through the network connection unit 122, the server 120 can be coupled to the charging device 110 and communicate with each other via the network 130.

The processor 126 can control related operations of software and hardware in the server 120 to perform the method for charging area management of electric vehicles of the invention, the details of which will be described later. For example, the processor 126 can be a general-purpose controller, a micro-control unit (MCU), a digital signal processor (DST), or the like, which provides the function of data analyzing, processing and computing. However, it is understood that the present invention is not limited thereto.

It should be understood that each of the elements, units or modules in the present embodiments may he a device having a corresponding function, which can have the appropriate hardware circuits or elements to perform the corresponding function, however, the device is not limited to be entity device, which can also be a virtual device having program and software with respective functions or a device having capabilities for processing and running the program and software. The manner of operations of the respective elements can further refer to the following description of the methods.

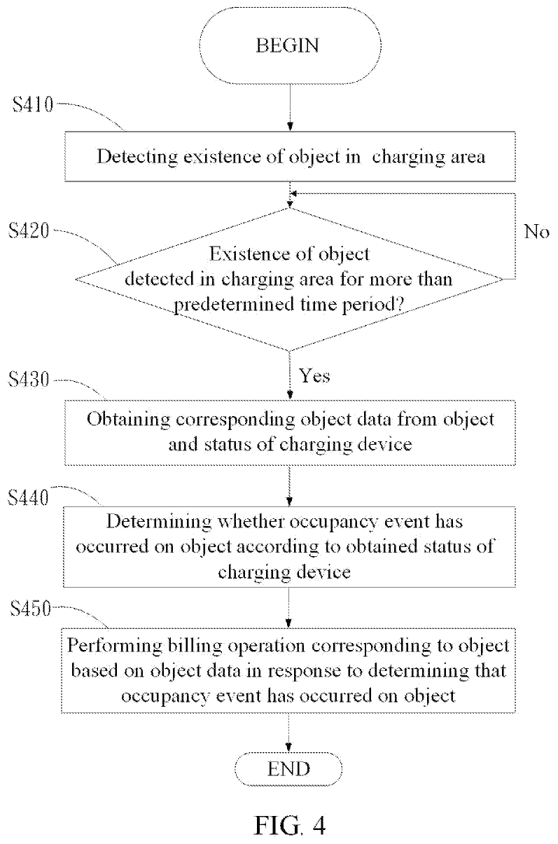

FIG. 4 is a flowchart of an embodiment of a method for charging area management of electric vehicles of the invention. The method for charging area management of electric vehicles of the invention can be applied to the server 120 and the charging device 110 as shown in FIG. 1. The server can be coupled to a plurality of charging devices electrically connected to at least one power supply device via a network, such as a wired network, a telecommunication network, and a wireless network, such as a Wi-Fi network. For example, the charging device can be an electric vehicle charger, which is provided with at least one charging connector, and outputs electric power through the charging connector to charger the vehicle.

First, in step S410, an existence of an object is detected for a charging area corresponding to the electric vehicle, and in step S420, it is determined whether the existence of the object is detected in the charging area for more than a predetermined time period, and if so, step S430 is performed.

In step S430, corresponding object data is obtained from the object and the status of the charging device is obtained. The detection of the existence of the object and the acquisition of the object data can be performed by the object sensing unit disposed in the charging device, or can be performed by an external device different from the charging device. The status of the charging device can be divided into a charging status and a non-charging status. The charging status indicates that the charging device is outputting power to a specific electric vehicle, and the non-charging status indicates other statuses where the charging device is not outputting power. For example, when the user has separated the charging gun of the charging device from the electric vehicle, it is in the non-charging status, and when the user plugs the charging gun of the charging device into the electric vehicle for charging, it is the charging status.

In one embodiment, for example, the object sensing unit can be a camera, which detects/senses the existence of an object (e.g., a vehicle) in a charging area such as a parking space corresponding to the charging device. When the object sensing unit is a camera, the object data is image data obtained by shooting the object. When the object is a vehicle, the image data serving as the object data taken by the camera serving as the object sensing unit includes image data corresponding to a license plate of the vehicle. For example, the object sensing unit can also be an electronic tag reader, which can automatically read the data recorded in the electronic tag placed on the object. When the object sensing unit is an electronic tag reader, the object data is the electronic tag data obtained from an electronic tag equipped with the object. For example, if the object is a vehicle, when the vehicle is equipped with a vehicle electronic tag that records data such as a license plate number, the electronic tag data read by the electronic tag reader serving as the object sensing unit may include the vehicle electronic tag data corresponding to the vehicle, and it contains vehicle-related data such as the license plate number and so on.

In step S440, when the object data is received, it is determined whether an occupancy event has occurred on the object according to the status of the charging device. In some embodiments, step S440 is to determine whether the charging device is not in a charging status for a predetermined period of time, and to determine whether the charging device is in a charging status based on a determination of whether the charging device is connected to an object and the detection of whether the charging device has output power. When the charging device is connected to the object and the charging device has output power, it is determined that the charging device is in a charging status. Contrarily, when it is determined that the charging device is in the charging status or the charging device is not in the charging status with a time period less than the predetermined time period, it is determined that no occupancy event has occurred on the object. When it is determined that the charging device is not in the charging status for more than the predetermined time period, it is determined that an occupancy event has occurred on the object.

When it is determined that no occupancy event has occurred on the object (No in step S440), the flow returns to step S440. In response to determining that an occupancy event has occurred on the object (Yes in step S440), in step S450, a billing operation corresponding to the object is performed according to the object data.

In some embodiments, step S450 may further comprise performing an object recognition procedure to determine whether the object is an electric vehicle and to determine the billing mechanism according to the determination result. The object recognition procedure may parse the object data to obtain a vehicle recognition data, then determines whether the object is an electric vehicle accordingly, and performs the billing operation for parking corresponding to the object according to the result obtained by the object recognition procedure. The vehicle identification data can be the license plate number of a vehicle. The parking billing operation corresponding to the object mentioned above includes calculating the parking tee (occupancy fee) of the object according to a specified rate.

In some embodiments, the aforementioned object recognition procedure may be performed by the processor of the charging device, or it may be performed by a remote server. When the object recognition procedure is performed by the remote server, the charging device transmits the object data to an external device (such as the remote server) through the communication unit to enable the object recognition procedure to be performed, such that the remote server can parse the object data to obtain a vehicle identification data, and determine whether the object is an electric vehicle accordingly.

In some embodiments, step S450 may perform different billing operations depending on whether the object is an electric vehicle or not. For example, when an occupancy event has occurred on the object and the object recognition procedure determines that the object is an electric vehicle, the billing operation corresponding to the object is performed with a first pricing rate, and when no occupancy event has occurred on the object and the object recognition procedure determines that the object is not an electric vehicle (e.g., a traditional vehicle powered by fossil fuels), the billing operation corresponding to the object is performed with a second pricing rate. In one embodiment, the first pricing rate and the second pricing rate are fixed pricing rates, and the second pricing rate is higher than the first pricing rate. For example, the first pricing rate can be 50 dollars for parking per half hour, and the second pricing rate may be 100 dollars for parking per half hour, but it is not limited thereto. In another embodiment, the first pricing rate is a fixed pricing rate, and the second pricing rate is a progressive pricing rate, For example, the first pricing rate can be 50 dollars for parking per half hour, the second pricing rate can be 50 dollars for the first half hour, 60 dollars for the second half hour, 70 dollars for the third half hour, and so forth. It is noted that the billing is added up accordingly. In other words, with a progressive pricing rate billing, the longer the parking space is occupied, the more parking fees will be charged, thereby reducing the chance of electric parking spaces being occupied for a long time. In the unlikely event that an electric parking space is being occupied, the charging station or charging area operator can also be compensated for the corresponding parking fee.

In some embodiments, when an occupancy event has occurred on the object and the object recognition procedure determines that the object is not an electric vehicle, a notification and alarm operation may further be performed. The notification and alarm operation is configured to issue a warning through an alarm unit to inform the owner of the vehicle to move the vehicle away within a limited time or to notify that the parking fee is about to be calculated. The notification and alarm operation may include a timing operation, and when the timing operation ends, the parking billing operation corresponding to the vehicle is started. For example, in one embodiment, the alarm unit 117 can be a siren or a speaker and the timing operation may have a timer count down from ten minutes. When the alarm operation is started, it can play audio or voice data, such as “This parking space is a parking space dedicated to charging electric vehicles. Non-charging vehicles will start charging certain fees soon. Please move your car away within ten minutes, thank you for your cooperation”, to inform the owner of the vehicle to move the car away within said time limit or to inform that the parking tee is about to be calculated. In some embodiments, when the electric parking space is stipulated that only electric vehicles can be parked and the object is not an electric vehicle, a parking violation report operation can be performed (for example, taking photos or photographing with a camera and uploading to the cloud) to issue a billing for the non-electric vehicle that has been illegally parked. In some embodiments, the successful examples of billing for the vehicle that has been illegally parked can be further posted in a prominent position near the electric vehicle parking space, so as to achieve the deterrent effect and reduce the chance of illegal occupation.

It should be noted that, in some embodiments, a display unit of a specific device, such as a display unit of a charging device or a display unit of a smart phone of a user corresponding to the object, can be used to display a countdown timing operation through a user interface. When it is detected that the object has left the charging area before the end of the timing operation, the process ends. In other words, when it is detected that the object has left the charging area before the end of the timing operation, the billing operation corresponding to the object is canceled. The billing operation corresponding to the object is performed when the countdown timing operation ends.

Therefore, the charging devices and related systems and methods for charging area management of electric vehicles of the present invention can manage a charging area corresponding to electric vehicle (e.g., exclusive parking space for electric vehicles corresponding to the charging device), and can determine whether to charge parking fees for a vehicle according to its vehicle data, a status of the charging device and predetermined occupancy conditions, and when the charging device detects that a vehicle in its corresponding charging area triggers a billing condition, automatically start or notify the remote server to perform a billing operation to calculate the parking fee for the vehicle, so a certain deterrent effect can be produced by the user payment mechanism, which effectively reduces the opportunity for the charging area corresponding to the charging device being occupied by non-electric vehicles or electric vehicles that are not charging for a long time or unlimited time, thus effectively improving the practicability and utilization rate of the charging device.

Methods for charging area management of electric vehicles, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for executing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for executing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalent.

What is claimed is:

1. A charging device for outputting electric power to charge an electric vehicle, comprising:
an object sensing unit configured to detect an existence of an object in a charging area, and obtain corresponding object data from the object; and
a processor coupled to the object sensing unit, configured to obtain a status of the charging device when receiving the object data from the object sensing unit, determine whether an occupancy event has occurred on the object according to the obtained status of the charging device, and perform a billing operation corresponding to the object based on the object data in response to determining that the occupancy event has occurred on the object.

2. The charging device of claim 1. wherein the processor further determines whether the occupancy event has occurred on the object according to the obtained status of the charging device by determining whether the charging device is not in a charging status for more than a predetermined time period and determining that the occupancy event has occurred on the object when the charging device is not in the charging status for more than the predetermined time period.

3. The charging device of claim 1, wherein the processor further performs the billing operation corresponding to the object based on the object data by enabling an object recognition procedure being performed to determine whether the object is an electric vehicle based on the object data, performing the billing operation corresponding to the object with a first pricing rate when determining that the object is the electric vehicle and performing the billing operation corresponding to the object with a second pricing rate when determining that the object is not the electric vehicle, wherein the second pricing rate is higher than the first pricing rate.

4. The charging device of claim 3, wherein the first pricing rate is a fixed pricing rate and the second pricing rate is a progressive pricing rate.

5. The charging device of claim 3, wherein the object recognition procedure further comprises the steps of parsing the object data to obtain a vehicle identification data, querying related information corresponding to the vehicle based on the vehicle identification data, and determining whether the object is the electric vehicle based on the related information corresponding to the vehicle.

6. The charging device of claim 2, wherein the processor further determines whether the charging device is not in the charging status by determining whether the charging device is connected to the object and detecting whether the charging device has output power.

7. The charging device of claim 1, further comprising an alarm unit for generating an alarm signal to perform a notification and alarm operation on the object in response to determining that the occupancy event has occurred on the object.

8. The charging device of claim 1, wherein the object data further comprises license plate image data.

9. The charging device of claim 1, wherein the object data is electronic tag data obtained from an electronic tag placed on the object.

10. A management system, comprising:
a computer device; and
a charging device for outputting electric power to charge an electric vehicle, wherein the charging device is connected to the computer device via a communication network, comprising:
an object sensing unit configured to detect an existence of an object in a charging area, and obtain corresponding object data fr©m the object; and
a processor coupled to the object sensing unit, configured to transmit the object data to the computer device upon receiving the object data from the object sensing unit to enable the computer device to obtain a status of the charging device, determine whether an occupancy event has occurred on the object according to the obtained status of the charging device, and perform a billing operation corresponding to the object based on the object data in response to determining that the occupancy event has occurred on the object.

11. A method for charging area management of electric vehicles for managing billing of a charging area of electric vehicles, wherein the charging area corresponds to a charging device, the method comprising:
detecting an existence of an object in a charging area, and obtaining corresponding object data from the object and a status of the charging device;
determining whether an occupancy event has occurred on the object according to the obtained status of the charging device; and
performing a billing operation corresponding to the object based on the object data in response to determining that the occupancy event has occurred on the object.
